(19) United States
(12) Patent Application Publication
(10) Pub. No.: US 2021/0312496 A1
(43) Pub. Date: Oct. 7, 2021

(54) MANAGEMENT SERVER AND MANAGEMENT PROGRAM

(71) Applicant: OMNIVISION CO.,LTD., Tokyo (JP)

(72) Inventor: Yasuyuki ITO, Tokyo (JP)

(21) Appl. No.: 17/280,950

(22) PCT Filed: Mar. 31, 2020
(86) PCT No.: PCT/JP2020/014864

§ 371 Date: Mar. 29, 2021

(30) Foreign Application Priority Data
Sep. 9, 2019 (JP) PCT/JP2019/035380

(51) Int. Cl. G06Q 30/02

(52) U.S. Cl. CPC G06Q 30/0246; G06Q 30/0201; G06Q 30/0217; G06Q 30/0273; G06Q 30/0215; G06Q 30/0243; G06Q 30/0272; G06Q 30/0211

(57) ABSTRACT

To appropriately give a reward to a provider of a content that has contributed to a sale of a product and to improve the quality of the content is a technical problem, and, as a solution to the problem, there is provided a management server that can perform a process of registering, for each product, a predetermined product introduction rule that needs to be observed in creating a product introduction video, a process of receiving the product introduction video from a provider, determining whether or not the product introduction video complies with the product introduction rule, and registering the product introduction video that complies with the product introduction rule in association with the product corresponding to the product introduction video, a process of, when a sale of the product is completed, specifying one or two or more product introduction videos that have contributed to the sale of the product among the product introduction videos that are viewed by a purchaser of the product out of a plurality of the product introduction videos that are registered in association with the product according to a predetermined specification rule determined in advance, a process of determining a reward for the provider who provides the product introduction video specified according to a predetermined reward determination rule determined in advance; and a process of storing reward information that indicates a reward determined.

### TECHNICAL FIELD

The present invention relates to a management server and a management program for determining a reward for a provider who provides a content that has contributed to the sale of a product.

### BACKGROUND ART

Product sellers have conventionally placed advertisements for selling products on websites via communication networks such as the Internet. For example, Patent Literature 1 discloses a system of placing a banner advertisement on a website that posts a content that introduces a product and guiding a customer to a website operated by a product seller.

### CITATION LIST

### Patent Literature

Patent Literature 1: JP 2001-117847 A

### SUMMARY OF INVENTION

### Technical Problem

However, Patent Literature 1 describes a system of giving a reward to the operator of a website that posts a banner advertisement based only on whether or not a customer has accessed a website operated by a product seller via the banner advertisement. For this reason, there is a problem that it cannot be determined whether the content posted on the website contributes to the sale of a product.

An object of at least one embodiment of the present invention is to solve the above problem and to provide a management server and a management program that appropriately gives a reward to a provider of a content that has contributed to a sale of a product. Since the reward can be appropriately given, it is also an object of the present invention to provide a management server and a management program that can be expected to improve the quality of a content that introduces a product.

### Solution to Problem

A management server according to the present invention includes a specification means for specifying one or two or more product introduction contents that have contributed to a sale of a product, a reward determination means for determining a reward for a provider who provides the product introduction content specified by the specification means, and a reward information storage means for storing reward information that indicates a reward determined by the reward determination means.

With the above configuration, it is possible to appropriately give a reward to the provider of the product introduction content that has contributed to the sale of the product. In addition, since the appropriate reward can be given, it can be expected to improve the quality of the product introduction content.

In addition, according to the management server of the present invention, the specification means may specify the product introduction content that has contributed to the sale of the product from the product introduction contents browsed by a purchaser who has purchased the product before the purchaser purchases the product according to a specification rule determined in advance.

With the above configuration, it is possible to accurately evaluate the product introduction content that has contributed to the sale of the product.

Further, according to the management server of the present invention, in determining rewards for a plurality of the providers, the reward determination means may determine the reward for each provider according to a reward determination rule determined in advance.

With the above configuration, the reward to be given can be different depending on the degree of contribution of the product introduction content, and thus it can be expected that the provider provides product introduction contents with higher quality.

Further, according to the management server of the present invention, the product introduction content may include a product introduction video.

With the above configuration, products are introduced more elaborately, and thus it can be expected that the provider provides product introduction contents with higher quality.

A management program according to the present invention implements a specification function that specifies one or two or more product introduction contents that have contributed to a sale of a product, a reward determination function that determines a reward for a provider who provides the product introduction content specified by the specification function, and a reward information storage function that stores reward information that indicates a reward determined by the reward determination function.

With the above configuration, it is possible to appropriately give a reward to the provider of the product introduction content that has contributed to the sale of the product. In addition, since the appropriate reward can be given, it can be expected to improve the quality of the product introduction content.

### Advantageous Effects of Invention

According to the present invention, it is possible to appropriately give a reward to the provider of the product introduction content that has contributed to the sale of the product. In addition, since the appropriate reward can be given, it can be expected to improve the quality of the product introduction content.

### BRIEF DESCRIPTION OF DRAWINGS

FIG. 1 is an explanatory diagram for explaining the outline of a product sales service according to the present invention.

FIG. 2 is a block diagram illustrating the overall configuration of a system 1 for achieving the product sales service.

FIG. 3 is a block diagram illustrating an example of a functional configuration of a management server 10.

FIG. 4 is an explanatory view for explaining an example of a database of product seller information registered in the product sales service by a setting/management unit 120.

FIG. 5 is an explanatory view for explaining an example of a database of product information registered in the product sales service by the setting/management unit 120.

FIG. 6 is an explanatory view for explaining an example of a database of instructor information registered in the product sales service by the setting/management unit 120.

FIG. 7 is an explanatory view for explaining an example of a database of a product introduction content registered in the product sales service and linked to a product by the setting/management unit 120.

FIG. 8 is an explanatory view for explaining an example of a database of customer information registered in the product sales service by the setting/management unit 120.

FIG. 9 is an explanatory view for explaining an example of a database related to a browsing history of the product introduction content in the product sales service by a product sales processing unit 140.

FIG. 10 is an explanatory view for explaining an example of a database related to a result of determination of an incentive by the product sales processing unit 140.

FIG. 11 is an explanatory view for explaining an example of a screen display of a product sales service site by the product sales processing unit 140.

FIG. 12 is an explanatory diagram for explaining an operation example of the determination of an incentive by an incentive determination processing unit 150 according to a first embodiment.

### DESCRIPTION OF EMBODIMENTS

### First Embodiment

A product sales service according to a first embodiment of the present invention is characterized by being capable of specifying a content that has contributed to the sale of a product and determining a reward for a provider who provides the content. Hereinafter, a configuration for achieving the product sales service will be described. Although the term “product” is used, it should be noted that the term “product” includes not only items such as electrical products, bicycles, and sporting goods, but also services such as insurance and travel applications, digital contents, and game tickets.

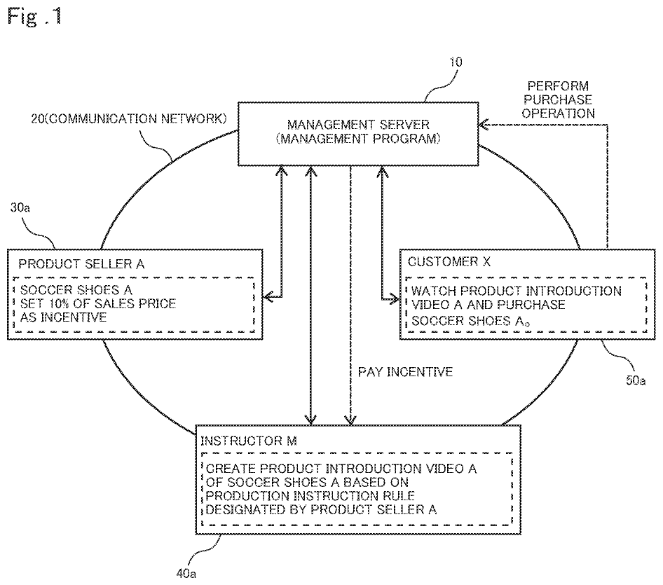

Hereinafter, the outline of the product sales service according to the present invention will be described with reference to the drawings. FIG. 1 is an explanatory diagram for explaining the outline of the product sales service according to the present invention. The product sales service includes at least a product seller who sells a product, an instructor who introduces the product sold by the product seller, and a customer who purchases the product sold by the product seller. Here, the instructor is an example of a provider who provides a product introduction content.

In this example, a management server 10 provides the product sales service. However, the function of selling a product may be provided by other devices other than the management server 10. The management server 10 is configured to be accessible via a communication network 20, and is also configured to be accessible to a terminal 30 of a product seller, a terminal 40 of an instructor, and a terminal 50 of a customer. Here, among the contents that introduce the product sold by the product seller (hereinafter, referred to as “product introduction contents”), the management server 10 specifies a product introduction content that has contributed to the sale of the product, determines an incentive for a provider who provides the product introduction content specified, and stores information indicating the incentive determined.

Here, the incentive means the money paid to the instructor who provides a product introduction video that has contributed to the sale of the product, and is an example of a reward. The product introduction content may include the product introduction video.

The example illustrated in FIG. 1 will be described. A terminal 30a of a product seller, a terminal 40a of an instructor, and a terminal 50a of a customer each transmit and receive information to and from the management server 10. Here, a product seller A registers soccer shoes A as a product in the management server 10 using the terminal 30a. Here, the product seller A registers a condition that when the soccer shoes A are sold, the incentive for the instructor who provides the product introduction video that has contributed to the sale of the soccer shoes A is set to 10% of the sales price in the management server 10 using the terminal 30a. In addition, the product seller A may register a rule that must be observed when the product of the product seller A is introduced as a product introduction rule using the terminal 30a.

On the other hand, an instructor M creates a video that introduces the soccer shoes A registered as a product by the product seller A as a product introduction video A that is an example of the product introduction content using the terminal 40a, and provides the video to the management server 10. The product introduction video A is created according to the product introduction rule registered by the product seller A.

Here, a customer X browses the product introduction video A created by the instructor M using the terminal 50a, and purchases the soccer shoes A. The management server 10 pays an incentive to the instructor M who provides the product introduction video A that has contributed to the sale of the soccer shoes A based on the completion of a process of selling the soccer shoes A to the customer X and the customer X's viewing history of the product introduction video A. Here, the incentive is 10% of the sales price as described above. The management server 10 does not need to pay the incentive to the instructor M when the soccer shoes A are sold, and may store the information indicating the incentive and pay the incentive at another timing.

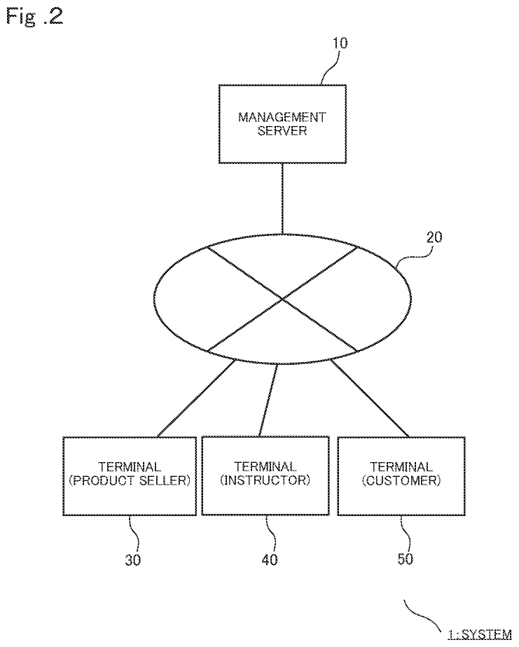

Next, an example of the overall configuration of the system 1 for achieving the product sales service according to the first embodiment will be described. FIG. 2 is a block diagram illustrating the overall configuration of the system 1 for achieving the product sales service. The system 1 for achieving the product sales service includes the management server 10, the terminal 30 of a product seller, the terminal 40 of an instructor, and the terminal 50 of a customer. The configuration of the system 1 is not limited to this, and it may be configured to use a single terminal by a plurality of people, or the system 1 may be configured to include a plurality of servers. In addition, the present server 10, the terminal 30 of a product seller, the terminal 40 of an instructor, and the terminal 50 of a customer are each connected to the communication network 20 such as the Internet.

Further, FIGS. 1 and 2 illustrate the single terminal 30 of a product seller, but it is needless to mention that a plurality of the terminals 30 of a product seller may be provided. That is, a plurality of product sellers may use the product sales service by using the respective terminals 30 that are connected to the communication network 20 and accessible to the management server 10. Similarly, a plurality of instructors and a plurality of customers may use the product sales service by using their respective terminals 40 and 50.

Moreover, it is described in FIGS. 1 and 2 that the management server 10 managed by the operating entity of the product sales service, the terminal 30 of a product seller, and the terminal 40 of an instructor are servers or terminals by different entities. However, as it is assumed that the operating entity of the product sales service is also the product seller, and that the operating entity of the product sales service is also the instructor, these entities may play a plurality of roles. Consequently, the present invention is not limited to the cases illustrated in FIGS. 1 and 2.

The terminal 30 of a product seller, the terminal 40 of an instructor, and the terminal 50 of a customer in FIGS. 1 and 2 are a PC (Personal Computer), a smartphone, a television receiver, a tablet terminal, and the like.

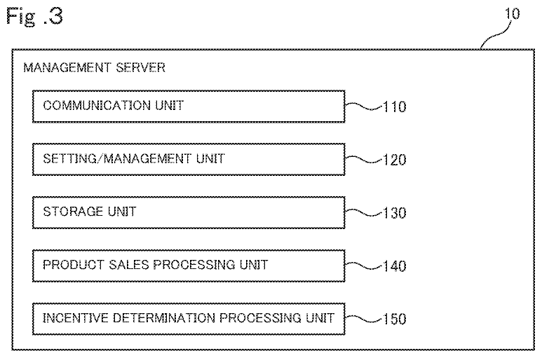

Next, an example of the functional configuration of the management server 10 according to the first embodiment will be described. FIG. 3 is a block diagram illustrating an example of the functional configuration of the management server 10. The management server 10 includes a communication unit 110, the setting/management unit 120, a storage unit 130, the product sales processing unit 140, and the incentive determination processing unit 150.

The communication unit 110 transmits and receives various pieces of information to and from one or two or more terminals 30 of a product seller, one or two or more terminals 40 of an instructor, and one or two or more terminals 50 of a customer via the communication network 20.

The setting/management unit 120 performs various settings and management for the product seller, the provider, and the customer to use the product sales service. It should be noted that the term “setting/management” includes registration, change, deletion, application, approval, and the like of various pieces of information. Hereinafter, cases where the setting/management unit 120 sets various pieces of information when the product sales service is performed will be described. Various pieces of information is stored in the storage unit 130, which will be described later.

### [Setting and Management Related to Product Seller]

First, an example of a setting and management process related to a product seller, the process being performed by the setting/management unit 120 based on the product seller inputting various pieces of information to the terminal 30, will be described.

The setting/management unit 120 registers product seller information that is necessary for selling products in the product sales service. The product seller information is information related to the product seller, such as a product seller name, a location, and a telephone number.

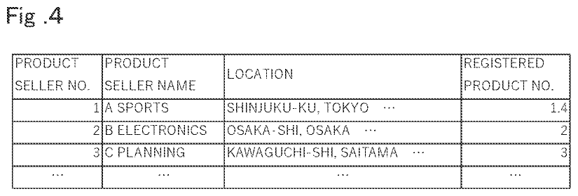

Here, an example of a database of the product seller information registered in the product sales service by the setting/management unit 120 will be described with reference to FIG. 4. In the example illustrated in FIG. 4, each product seller is assigned and registered with a product seller No., which is identification information, and the corresponding product seller name, the location of the product seller, and a product No. assigned to a product registered in the management server 10 by the product seller are registered. The number (No.) that identifies the respective information such as the product seller No. may be an alphanumeric character, a symbol, or the like as long as it can be identified.

In addition, the setting/management unit 120 registers product information related to products sold by the product seller. The product information is information indicating, for example, a product name or a product number, a size, a weight, a description, a product image/moving image, and the like. In addition, the product information may also include a product sales start date and time, a product sales end date and time, and a display start date and time and a display end date and time on a product sales service site.

Further, the setting/management unit 120 sets a product introduction rule that must be observed in creating a product introduction content that introduces a product sold by the product seller. The product introduction rule is composed of one or two or more rules. Examples of the product introduction rule to be set include a rule that a predetermined matter regarding a product must be introduced, a rule that the product must be introduced using a predetermined expression, and a rule that the product must be introduced in a predetermined order. In addition, the product introduction rule includes a method of determining a reward to be given when the product is sold. By determining the product introduction rules as described above, it is possible to maintain the quality of a product introduction content provided by a provider. In addition, even when a plurality of providers provide product introduction contents in order to introduce the same product, the providers can compete with each other while a certain quality is maintained. It should be noted that the provider agrees to the product introduction rule and creates the product introduction content. For example, the provider transmits information indicating that the provider agrees to the product explanation rule to the management server 10 using the terminal 40 of a provider.

It should be noted that the setting/management unit 120 may set the product introduction rule for each predetermined category such as an effect, a function, a design, or the like of one product. In that case, the provider agrees to the product introduction rule for each predetermined category, and creates a plurality of product introduction contents according to the respective product introduction rules. For example, the provider may use the terminal 40 to input that the provider agrees to all the product explanation rules corresponding to the categories at once to the terminal 40, or to input that the provider agrees to only the product explanation rule common to the categories at once, or to input that the provider individually agrees to the product explanation rule completely for each category to the terminal 40.

Further, the setting/management unit 120 may set a condition for a provider who creates a product introduction content that introduces a product to be sold, as the product introduction rule. Examples of the condition for the provider include familiarity with the field to which the product belongs and the like. For example, if the product is exercise equipment, the condition for the provider is that the provider has at least three years of experience as a trainer in a gym. Moreover, for example, if the product is wine, the condition for the provider is that the provider is qualified as a sommelier. As described above, by setting the condition for the provider according to the product to be sold, it is possible to receive only an offer of high-quality product introduction contents based on experience and knowledge.

In addition, the age of the provider may be set as the condition for the provider. For example, when the product seller registers a product targeting a specific age group in the management server 10, the product seller sets the age of the provider within the age group. As a result, the product seller can cause the provider to create a product introduction content with which the customer can feel a closeness and empathy.

The setting/management unit 120 may set a recruitment period for providers. Further, the setting/management unit 120 may end the recruitment at the stage of securing the providers who satisfy the predetermined conditions, and on the other hand, if the providers who satisfy the satisfactory conditions cannot be secured, the setting/management unit 120 may change the setting of the period so that the recruitment continues even after the recruitment period has elapsed.

In addition, the setting/management unit 120 sets a reward when the product introduction content that introduces a product has contributed to the sale of the product. The incentive, which is an example of the reward, may be, for example, a fixed amount of money for each product that has contributed to sales, or may be an amount of money equal to a predetermined ratio to the price of the product that has contributed to sales. Further, for example, when the product is participation in a free event or the like for which no sales price for participation is needed, the incentive may be a fixed amount of money per participant or a fixed amount of money for each participation of a predetermined number of people. In addition to cash, the reward may be electronic money, points in the retail or service industry, or in-kind.

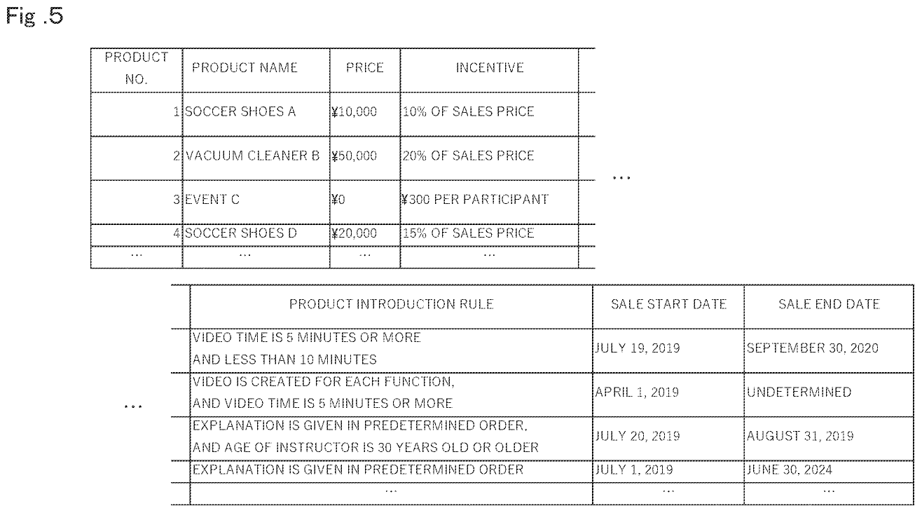

Here, an example of a database of product information registered in the product sales service by the setting/management unit 120 will be described with reference to FIG. 5. In the example illustrated in FIG. 5, each product is assigned and registered with a product No. that is identification information. In addition, a product name, a price, an incentive, a product introduction rule, a sale start date, and a sale end date are registered corresponding to each product No. Here, in the case of a product with product No. 1 and a product name of soccer shoes A, the incentive is 10% of the sales price, and the product introduction rule is that the video time of a product introduction video is 5 minutes or more and less than 10 minutes. Further, in the case of a product with a product No. 2 and a product name of vacuum cleaner B, the incentive is 20% of the sales price, and the product introduction rule is that the product introduction video is created for each product function and the video time of each product introduction video is 5 minutes or more. It should be noted that the sales end date of the product with product No. 2 is undecided.

In the case of a product with product No. 3 and a product name of event C (participation in event C), the price is 0 yen (free participation), and the incentive is 300 yen for each participant. In addition, the product introduction rule is that an explanation is given in a predetermined order and the age of an instructor who creates the product introduction video is 30 years old or older. In the case of a product with product No. 4 and a product name of soccer shoes D, the product introduction rule is to give an explanation in a predetermined order.

### [Setting and Management Related to Provider]

Next, an example of a setting and management process related to a provider, the process being performed by the setting/management unit 120 based on the provider inputting various pieces of information to the terminal 40, will be described.

The setting/management unit 120 registers provider information that is necessary for providing a product introduction content. The provider information is information related to an instructor such as a provider name, a location, a telephone number, and a specialized field. Here, the provider may submit data certifying the qualification and age of the provider to the management server 10.

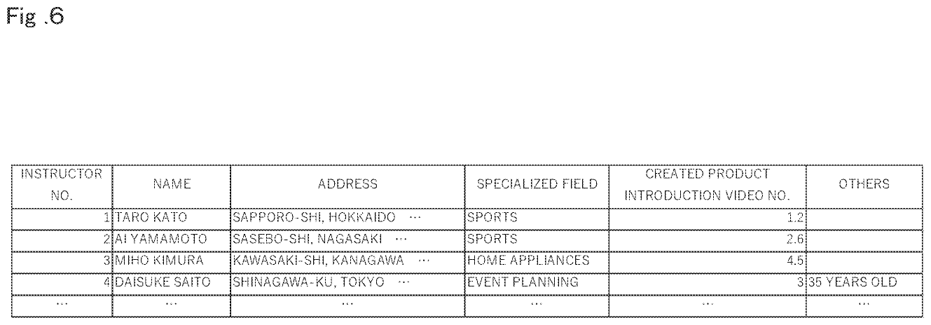

Here, an example of a database of instructor information registered in the product sales service by the setting/management unit 120 will be described with reference to FIG. 6. In the example illustrated in FIG. 6, the instructor No., which is the identification information, is assigned and registered, and the corresponding instructor name, the location of the instructor, the specialized field of the instructor, and the number of a product introduction video provided by the instructor to the management server 10 are registered. It should be noted that the instructor with instructor No. 4 is registered as 35 years old as another information.

The setting/management unit 120 may register not only a single provider but also a plurality of providers as a set of providers. An example of a set of providers is a set of providers in which any one provider is determined as a representative provider and other providers are determined as subordinate providers. In that case, for example, if only the representative provider is agree to the product introduction rule, the subordinate providers may be regarded as being agree to the product introduction rule as well. Further, when the reward is given to a set of providers, the representative provider may receive the reward first and distribute the received reward to the subordinate providers. In addition, another example of a set of providers is a set of providers in which the work of creating a product description content is shared by group providers who do not have a predetermined role. The setting/management unit 120 may determine in advance the distribution of the reward when any of the group providers receives the reward. By registering the providers as a set as described above, it is possible to further diversify the activity method of the providers and, as a result, improve the quality of the product introduction content.

In addition, when a set of providers creates a plurality of product introduction contents by dividing the contents into predetermined categories, a plurality of different providers may be assigned to the respective product introduction contents. For example, in the case of creating the product introduction content for each product function, it is possible to assign a provider who is familiar with each function to take charge, and thus it is possible to improve the quality of the product introduction contents as a whole. The reward received as a contribution to the sale of the product may be distributed to the providers who create the product introduction contents for the respective product functions.

### [Settings and Management Related to Product Introduction Content]

Next, an example of a setting and management process related to a product introduction content performed by the setting/management unit 120 will be described.

The setting/management unit 120 registers product introduction contents transmitted from providers. When the product introduction content is provided to the management server 10 and then registered, it is checked whether the production introduction content complies with the product introduction rule, and the product introduction content is linked to the introduced product. For example, the setting/management unit 120 automatically checks, for example, whether or not the video time in the product introduction rule is within a specified range. Meanwhile, for example, whether the product is explained in a predetermined order is checked by a product seller, a product sales service operator, or a third party entrusted with a service operation. When it is confirmed that the product introduction content provided complies with the product introduction rule, the setting/management unit 120 registers the product introduction content on the management server 10. When the product introduction content is a product introduction video or a product introduction voice, the provider who introduces the product does not necessarily need to appear. The setting/management unit 120 does not need to check whether the product introduction content complies with the product introduction rule, and instead, for example, the product seller may approve the product introduction content and link the content to the product.

Further, the setting/management unit 120 may link one product introduction content to a plurality of products. Specifically, the setting/management unit 120 may link the product introduction content that introduces a plurality of products to the products. Examples of a case of introducing a plurality of products include a case where a plurality of products are used as a set, a case where a plurality of products are delivered to customers at different times, and a case where products are purchased on a regular basis, and the like. Since the product can be introduced according to a sales pattern as described above, it is possible to introduce the product more attractively.

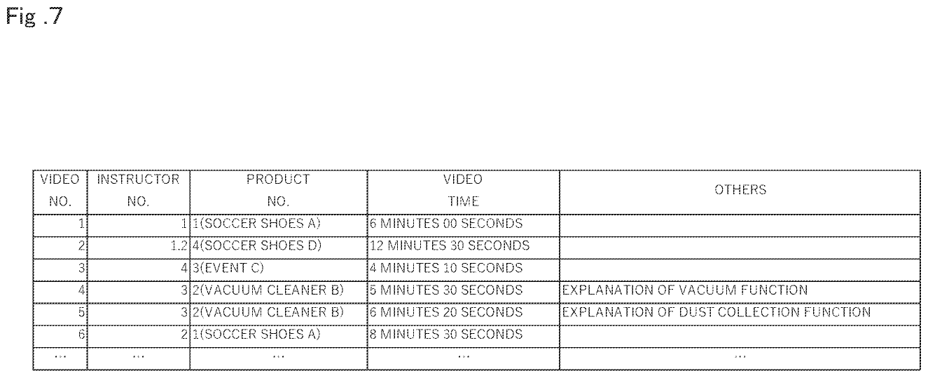

Here, an example of a database of a product introduction content registered in the product sales service and linked to a product by the setting/management unit 120 will be described with reference to FIG. 7. In the example illustrated in FIG. 7, the product introduction video that is an example of the product introduction content is assigned with a video No. that is the identification information. In addition, an instructor No., a linked product No., a video time, and others (only when necessary) are registered corresponding to each video No. Here, since the product introduction video with video No. 2 is created by two instructors, 1 and 2 are registered as the instructor No. In addition, the product introduction videos with video Nos. 4 and 5 are product introduction videos that introduce the respective functions of the product with product No. 2, and which function is introduced is indicated in the column “others”.

### [Setting and Management Related to Customer]

Next, an example of a setting and management process related to a customer, the process being performed by the setting/management unit 120 based on the customer inputting various pieces of information to the terminal 50, will be described.

The setting/management unit 120 registers customer information that is necessary for the customer to purchase a product. The customer information includes, for example, a customer name, a delivery destination of a product, a telephone number, a usage pattern of a product sales service, and the like. Here, examples of the usage pattern of the product sales service include a member who agrees to the site policy of the product sales service and registers customer information in the management server 10, a guest who does not register information in the management server 10 and provides various pieces of information every time using the product sales service, and the like.

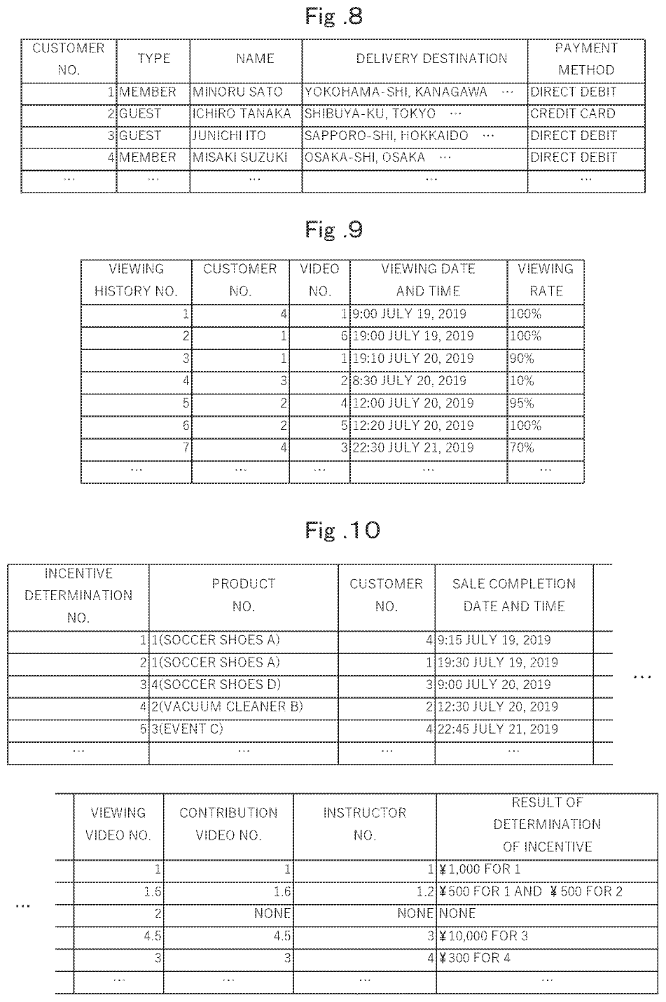

Here, an example of a database of the customer information registered in the product sales service by the setting/management unit 120 will be described with reference to FIG. 8. In the example illustrated in FIG. 8, each customer is assigned and registered with a customer No., which is the identification information, and the corresponding customer name, a delivery destination of a product, and a method of paying a purchase price of a product are registered.

### [Setting and Management Related to Specification of Product Introduction Content That Has Contributed to Sale of Product]

Next, an example of setting and managing a method of specifying a product introduction content that has contributed to the sale of a product by the setting/management unit 120 will be described.

The setting/management unit 120 sets a specification rule for specifying one or two or more product introduction contents that has contributed to the sale of the product. That is, the specification rule is a rule that specifies the product introduction content for which the reward is received when the customer purchases the product in the product sales service. The specification rule is determined in advance based on the customer's browsing history of the product introduction content or the like. The specification rule may be determined for each product, or may be determined for each product seller. Hereinafter, an example of a specification rule in a case where a customer browses a product introduction content that introduces a product and then purchases the product will be described.

For example, the specification rule is that when the customer purchases the product within a predetermined time after browsing the product introduction content, the product introduction content is specified as a product introduction content that has contributed to the sale of the product (hereinafter, also referred to as “sales contribution content”). By evaluating the product introduction content that causes the customer to directly purchase the product, it is possible to expect the offer of the product introduction content that not only informs the customer of the product information but also motivates the customer to actually purchase the product.

In addition, the specification rule may be to specify the product introduction content that introduces a product that is browsed by the customer before the product is purchased as the sales contribution content. Here, when the customer has browsed a plurality of product introduction contents, the specification rule may be to specify any of the product introduction contents as the product introduction content that has contributed to the sale of the product. For example, when any of the product introduction contents is specified, the sales contribution content may be specified based on a browsing order, for example, the sales contribution content may be specified as a content browsed last, a content browsed first, or a content browsed second to last. Further, when the customer has browsed a plurality of product introduction contents, two or more product introduction contents may be specified as the sales contribution contents. For example, the product introduction contents up to a predetermined number from the last in the browsing order or all the product introduction contents browsed may be specified as the sales contribution contents.

Moreover, when the customer has browsed a plurality of product introduction contents, the specification rule may be to specify the product introduction content with the longest browsing time among the product introduction contents as the sales contribution content.

As a result, it is possible to evaluate the product introduction content that the customer obtains the most information and is most influenced by, and for example, it is possible to expect the offer of product introduction contents that the customer can continue to browse without getting tired. It should be noted that when the product introduction content includes a product introduction video, the product introduction content is specified based on the viewing time of the video. Further, when the customer has browsed a plurality of product introduction contents, the specification rule may be to specify the product introduction content with the highest browsing count among the product introduction contents as the sales contribution content.

In addition, the specification rule may be to specify the product introduction content whose predetermined part is browsed as the sales contribution content. Here, the predetermined part is, for example, the content that introduces the main function of the product or the content that introduces the unique feature of the product among the contents that can be browsed in the product introduction content. By evaluating the product introduction content in which the predetermined part is browsed to inform the customer of important information about the product, it is possible to more accurately specify the sales contribution content.

Meanwhile, the relationship between the product introduction content and the purchase of the product may be determined and specified based on the access date and time of each piece of information by the terminal 50 of a customer, as described above. However, for example, when the terminal 50 of a customer has a screen display function, the relationship may be specified based on the transition information of pages accessed by the terminal 50 of a customer. That is, the specification rule may be to specify the product introduction content as the sales contribution content based on the transition information from the page that posts the product introduction content. For example, when a direct transition from a page that posts the product introduction content to a product purchase page is performed, the product introduction content may be specified as the sales contribution content. When the transition from the page that posts the product introduction content to an unrelated page, and then to the product purchase page is performed, the product introduction content does not need to be specified as the sales contribution content. The case where the transition to another page on the way and then to the product purchase page is performed may include a case where the transition relationship between the page that posts the product introduction content and the product purchase page cannot be grasped because it is impossible to link back from the product sales site.

The specific examples of the specification rules described above may be used in combination with each other. The method of determining specification rules may differ depending on the type and sales method of products, and the like. By determining the specification rules in advance, competition occurs between a plurality of providers, and the improvement in the quality of product introduction contents can be expected. Even when the customer purchases the product after browsing the product introduction content, if there is no product introduction content specified based on the specification rule, it may be determined that there is no product introduction content that has contributed to the sale of the product.

### [Setting and Management Related to Reward Determination]

Next, an example of setting and managing a method of determining a reward for a provider who provides a sales contribution content by the setting/management unit 120 will be described.

First, when all the providers who create one or two or more sales contribution contents are the same person, the provider receives all the predetermined reward.

On the other hand, when there are a plurality of sales contribution contents specified, the setting/management unit 120 determines a reward determination rule that is a method of determining an incentive for the providers who provide sales contribution contents in determining the rewards for the providers. The reward determination rule is a method of distributing a reward to a plurality of providers who provide sales contribution contents. Hereinafter, an example of the reward determination rule will be described.

For example, the reward determination rule may be to distribute the reward evenly to the respective sales contribution contents. That is, the reward is evenly divided by the number of sales contribution contents. Consequently, when two or more sales contribution contents are provided by the same provider, the provider receives a reward for each sales contribution content provided. As the reward is divided for each sales contribution content, it is possible to cause the provider to create more product introduction contents for one product. On the other hand, the reward determination rule may be to distribute the reward evenly to the respective providers who provide the sales contribution contents. That is, the reward is divided by the number of providers regardless of the number of sales contribution contents provided. As the reward is divided for each provider, it can be expected to prevent product introduction contents from being excessively created.

In addition, the reward determination rule may be that rewards the provider who provides the sales contribution content that is estimated to have a higher degree of contribution to sales than other sales contribution contents among a plurality of sales contribution contents more than other providers. For example, the reward determination rule may be that the reward for the provider who provides the sales contribution content that is browsed last by a customer before the sale of the product is completed, among the plurality of sales contribution contents, is more than that for other providers. As described above, by giving a larger amount of reward to the provider who provides the sales contribution content that is likely to be the decisive factor in purchasing the product, it can be expected that the provider provides high-quality product introduction contents. It should be noted that the reward determination rule may be to determine the reward according to the degree of contribution of each sales contribution content. That is, the reward determination rule may be that the reward received increases as the number of sales contribution contents with a high degree of contribution increases. Examples of a method of determining the degree of contribution to sales include a determination based on whether or not the sales contribution content is last browsed by the customer before the sale of the product is completed and a determination based on whether or not the browsing rate of the sales contribution content is high.

The examples of various setting and management processes by the setting/management unit 120 have been described above.

Referring to FIG. 3 again, the storage unit 130 stores various pieces of information related to the product sales service on the management server 10. For example, the storage unit 130 stores information related to the product seller, the provider, and the customer, the information being set by the setting/management unit 120 as described above. The storage unit 130 is an example of a reward information storage unit that stores information related to product sales by the product sales processing unit 140 to be described later, and reward information indicating the reward determined by the incentive determination processing unit 150. The storage unit 130 may store the reward information so as to be aggregated for each provider.

The product sales processing unit 140 performs various processes related to the sale of products to customers registered in the product sales service. For example, the product sales processing unit 140 performs a process of displaying various pieces of information related to the sale of a product on the terminal 30 of a customer that has accessed a product sales service site at the time of the sale of the product. It should be noted that the customer may access the product introduction service site using a predetermined application stored in the terminal 30.

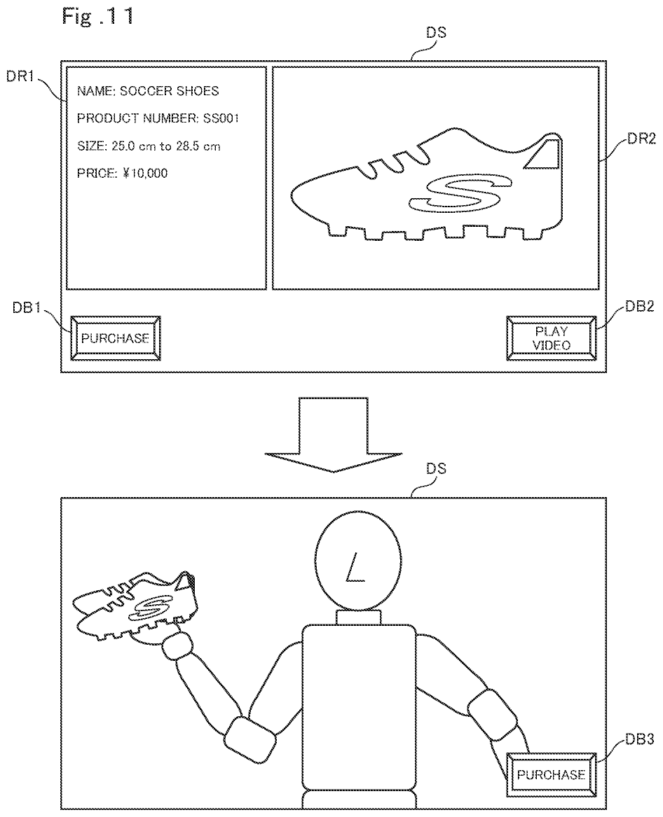

Here, an example of a screen display of a product sales service site by the product sales processing unit 140 will be described with reference to FIG. 11. The upper part of FIG. 11 illustrates a display screen DS for introducing and selling a product. On the display screen DS, a region DR1 that shows product information, a region DR2 that shows a thumbnail of a product introduction video, a purchase button DB1 that allows a customer to purchase a product, and a video play button DB2 that allows the customer to play a product introduction video are shown.

Here, when the customer operates the video play button DB2 on the terminal 30, as illustrated in the lower part of FIG. 11, the product introduction video that introduces the product whose product information is displayed in the upper part of FIG. 11 is played on the entire display screen DS. In the product introduction video, the instructor introduces the product. As illustrated in the lower part of FIG. 11, a purchase button DB3 that allows the customer to perform a purchase procedure of the product is shown while the product introduction video is playing on the entire display screen DS. Since it is possible to perform the purchase procedure while the product introduction video is playing, it can be expected that the customer does not miss the timing when the customer wants to purchase the product, which leads to the purchase of the product.

The sales process based on the operation of the purchase buttons DB1 and DB3 may be completed on the same page, or may be moved to another page and completed on the page. When the sales process is performed on another page, the storage unit 130 stores the transition from the page where the product introduction content is displayed as illustrated in the upper part of FIG. 11 to the page where the sales process is performed by URL links, tag setting, or the like.

The example of the screen display illustrated in FIG. 11 is merely an example, and is not limited to such an example. The product information, the product introduction content, and the purchase page may be displayed on separate pages, or a part or all of them may be displayed on the same page. The product introduction video may be played in the region DR2 showing the thumbnail of the product introduction video in the upper part of FIG. 11. When the terminal 50 of a customer is a terminal capable of voice recognition processing, the video play process and the product purchase process may be performed based on the customer's voice recognized by the terminal 50 of a customer. In the example illustrated in FIG. 11, the product introduction content is a product introduction video, but for example, when the terminal 50 of a customer is a smart speaker, the product may be introduced only by voice.

Here, an example of a database related to a browsing history of a product introduction content in the product sales service by the product sales processing unit 140 will be described with reference to FIG. 9. In the example illustrated in FIG. 9, a viewing history No. is assigned, and the corresponding customer No., a product introduction video No., a viewing date and time, and a viewing rate are recorded. The incentive determination processing unit 150, which will be described later, refers to the database illustrated in FIG. 9 and performs a process of specifying a sales contribution content and a process of determining an incentive.

The description will be continued returning to FIG. 3. The incentive determination processing unit 150 is an example of a specification unit that specifies one or two or more product introduction contents (sales contribution contents) that have contributed to the sale of a product. The incentive determination processing unit 150 may specify the sales contribution content according to the specification rule described above.

The incentive determination processing unit 150 is also an example of a reward determination unit that determines a reward for a provider who provides a product introduction content specified. When determining a reward for a plurality of providers, the incentive determination processing unit 150 may determine the reward for the providers according to the reward determination rule described above.

Further, the incentive determination processing unit 150 stores the reward information indicating the determined reward in the storage unit 130, which is an example of the reward information storage unit. The reward information is, for example, information indicating a product sold, information indicating a product introduction content and a sales contribution content browsed by a customer, information indicating a provider who provides the sales contribution content, and information indicating the result of distribution of a reward.

When the provider receiving the reward is any of a set of providers described above, the reward is received and then further distributed within the set of providers.

Here, an example of a database related to a result of determination of an incentive by the product sales processing unit 140 will be described with reference to FIG. 10. In the example illustrated in FIG. 10, an incentive determination No. is assigned, and a product No., a customer No. who has purchased the corresponding product, a sale completion date and time, a viewing video No. of a product introduction video viewed by a customer before a product is purchased, a sales contribution video No. specified by the incentive determination processing unit 150, an instructor No. who provides a sales contribution video, and a result of determination of an incentive determined by the incentive determination processing unit 150, which is an example of the reward information, are recorded.

It is recorded in incentive determination No. 1 that the incentive determination processing unit 150 specifies the product introduction video with viewing video No. 1 that is viewed by the customer with customer No. 4 before the customer purchases the soccer shoes A with product No. 1 as a contribution video, and 1000 yen, which is 10% of the price of the soccer shoes A, is determined as an incentive. In addition, it is recorded in incentive determination No. 2, the incentive determination processing unit 150 specifies two contribution videos, 10% of the price of the soccer shoes A is evenly distributed, and an incentive of 500 yen is determined for each of two instructors.

For example, if the specification rule stipulates that the viewing rate of the product introduction video is 50% or more, it is recorded in incentive determination No. 3 that the customer has viewed the product introduction video with video No. 2 before purchasing the product, but since the viewing rate of the product introduction video is 10% as indicated in viewing history No. 4 in FIG. 9, the incentive determination processing unit 150 does not specify that the product introduction video with video No. 2 has contributed to the sale of the product, and determines that there is no sales contribution video. As a result, in incentive determination No. 3, there is no instructor to pay the incentive.

It is recorded in incentive determination No. 4 that the incentive determination processing unit 150 specifies the product introduction video with viewing video No. 4 and the product introduction video with the viewing video No. 5 that respectively introduce the different functions of the vacuum cleaner B as illustrated in FIG. 7 as sales contribution videos, and the incentive is paid to the instructor with No. 3, who provide these videos. It is recorded in incentive determination No. 5 that the customer with No. 4 participates in the free event C with product No. 3, the incentive determination processing unit 150 specifies the product introduction video with viewing video No. 3 as a contribution video, and 300 yen, which is an incentive of a predetermined participant, is paid.

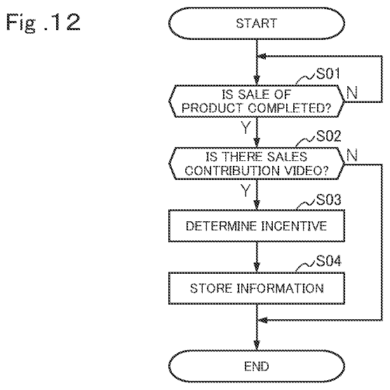

Next, an operation example of the determination of an incentive by the incentive determination processing unit 150 according to the first embodiment will be described with reference to a flowchart of FIG. 12. First, when the product sales processing unit 140 does not complete the sale of a product to a customer (S01: N), the process returns to step S01. On the other hand, when the product sales processing unit 140 completes the sale of the product to the customer (S01: Y), the incentive determination processing unit 150 performs a process of specifying a sales contribution video, and when there is no sales contribution video (S02: N), the operation ends.

On the other hand, when the incentive determination processing unit 150 performs the process of specifying the sales contribution video and specifies one or two or more sales contribution videos (S02: Y), the incentive determination processing unit 150 determines an incentive for a provider who provides the sales contribution video specified (S03). When determining the incentive, the incentive determination processing unit 150 stores reward information indicating the result of determination of the incentive (S04), and the operation ends.

As described above, the management server 10 according to the present invention can specify one or two or more product introduction contents that have contributed to the sale of a product, determine a reward for a provider who provides the product introduction content specified, and store reward information indicating the reward determined. Consequently, it is possible to achieve a management server that appropriately gives the reward to the provider of a sales contribution content. Further, since the management server 10 according to the present invention can give an appropriate reward, it is possible to achieve a management server that can be expected to improve the quality of a product introduction content. In addition, when the management server 10 according to the present invention is configured to specify the product introduction content that has contributed to the sale of the product from the product introduction contents browsed by a purchaser who has purchased the product before the purchaser purchases the product according to a predetermined specification rule, it is possible to accurately evaluate the product introduction content that has contributed to the sale of the product. Moreover, in determining rewards for a plurality of providers, when the management server 10 according to the present invention is configured to determine the reward for each of the providers according to a predetermined reward determination rule, the reward to be given can be different depending on the degree of contribution of the product introduction content, and thus it can be expected that the provider provides product introduction contents with higher quality. Furthermore, according to the management server 10 of the present invention, when it is configured that the product introduction content includes a product introduction video, products are introduced more elaborately, and it can be expected that the provider provides product introduction contents with higher quality.

### Second Embodiment

In the first embodiment, the customer browses a product introduction content and purchases a product in the same product sales service, but the purchase of the product may be performed by another website or a physical store linked to the product sales service. The incentive determination processing unit 150 specifies the sales contribution content by associating the information indicating the sale of the product at another website or the physical store with the customer's browsing history of the product introduction content. Hereinafter, a specific description will be given. The description of the same configuration as that of the first embodiment will be omitted.

The setting/management unit 120 registers a browsing code corresponding to the browsing history of each product introduction content registered. The browsing code may be any information capable of identifying the browsing history of the product introduction content, such as alphanumeric characters, character strings, and barcodes. The browsing code is registered in a product introduction content database so as to correspond to each product introduction content. In addition, the product sales processing unit 140 also displays the corresponding browsing code when displaying the product introduction content on the terminal 30 of a customer. For example, when a customer purchases a product introduced by a product introduction content in another website or a physical store linked to the product sales service, the customer presents the browsing code to the other website or the physical store. Examples of a method of presenting the browsing code include direct input of the browsing code, reading of a barcode by a POS cash register terminal, and the like. Here, the purchase of the product at the physical store includes, for example, a case where the customer completes the purchase procedure of the product on the website and then receives the product at the physical store.

The operators of the other website and the physical store provide the browsing code presented by the customer, the name of the product sold, and the date and time of sale of the product to the management server 10 of the present system. The incentive determination processing unit 150 of the management server 10 specifies the product introduction content as a sales contribution video based on a customer name recorded in the browsing history corresponding to the browsing code provided, the product name introduced by the product introduction content, the provided name of the product sold, and the provided date and time of sale of the product. At this time, the customer information does not need to be shared between the present product sales service and the operator of the other website or the physical store. Further, in specifying the sales contribution video, the product ID managed by the other website or the physical store may be used instead of the product name or in addition to the product name. As described above, since the sales performance on the other website and the physical store is also linked to incentives, providers have more opportunities to receive incentives, so that it can be expected to improve the quality of the product introduction content.

Various configurations may be adopted in addition to the contents described in the first and second embodiments. For example, any product introduction rule may be set. Specifically, the product introduction rule may include the content that regulates the morals that the purchaser should be aware of, such as not including the content that denies products of other companies, the regulation to reflect the request of a product seller (product creator) such as whether the product is explained in a predetermined order, and the content that regulates the technical conditions related to the content such as the volume of the product introduction video must have a play time of 10 minutes or more. In addition, any method may be used to determine whether or not the product introduction content created by the provider complies with the product introduction rule. For example, the technical condition that the volume of the product introduction video must have a play time of 10 minutes or more can be determined by analyzing the data of the product introduction content on the management server 10. Further, it may be configured so that when the provider registers the product introduction content, the data indicating that the provider has pledged to comply with the product introduction rule is transmitted to the management server 10. For example, a check box for a sentence for confirming compliance with the product introduction rule such as “There is no doubt that the product introduction video I provide is created to comply with the product introduction rules.” may be presented on the browser for registering the product introduction video on the management server 10, and only when the provider checks the check box and transmits the answer, the product introduction video may be registered as the product introduction video that complies with the product introduction rules.

In addition, the specification rule may be adopted that the purchaser can select product introduction videos that are thought to have contributed to the purchase decision by the purchaser, and among the product introduction videos selected, the product introduction videos, the predetermined number of which is, for example, up to n (n is natural number), are specified as product introduction videos that have contributed to the sale of the product. As a method of selecting the product introduction video by the purchaser, for example, a list of product introduction videos viewed by the purchaser may be presented to the purchaser, and a product introduction video that is thought to have contributed to the purchase decision by the purchaser may be selected by checking a check box, for example, and transmitted to the management server 10 as selection information, or the information containing the URL of the product introduction video that is thought to have contributed to the purchase decision by the purchaser may be transmitted to the management server 10 as the selection information. That is, any method may be used as long as the management server 10 can acquire the selection information regarding the product introduction video that is thought to have contributed to the purchase decision by the purchaser.

Moreover, the number of product introduction videos that can be selected as the product introduction video that is thought to have contributed to the purchase decision by the purchaser may be limited to a predetermined number (for example, m or less (m is natural number)). Furthermore, the selection information may include ranking information in which the purchaser ranks the plurality of product introduction videos according to the degree of contribution. For example, if it is necessary to specify product introduction videos, the number of which is less than the number of product introduction videos selected by the purchaser, as product introduction videos that have contributed to sales (when m≥number of product introduction videos selected by purchaser>n), n product introduction videos from a product introduction video with a highest ranking in ascending order in the ranking information may be specified as the product introduction videos that have contributed to the sale of the product. In addition, the incentives provided to the providers may be different based on the ranking information.

Further, as a precondition for applying various specification rules, the minimum viewing time of a product introduction content may be set. For example, it is conceivable to set the minimum viewing time of the product introduction video to 30 seconds. If this precondition is set, for example, a product introduction video viewed for only 10 seconds may be excluded from the candidates for the product introduction video that has contributed to the sale of the product, and the specification rule does not need to be applied to the product introduction video.

Further, the product sales service may be provided by not only the management server 10 but also an external sales site linked to the management server 10. By linking to external sales sites and EC malls, customers can view product introduction videos and then purchase products even when product sellers sell products at a plurality of sales sites and EC malls, the providers of the product introduction videos can be the target of incentives.

In addition, the management server 10 may be configured to be linked to the websites or product introduction sites of stores where the product can be purchased such as a department store, a convenience store, a pharmacy, and a home center, these stores providing the product sales service. After browsing these sites and the product introduction video, the customer displays or downloads a unique specification method (video viewing code) such as a reception number or a QR code (registered trademark) on the terminal of a purchaser, the customer presents the reception number or QR code (registered trademark) acquired at the time of purchasing the product at the store, and the link between the purchase and the video viewing code is checked at a store's sales device (POS or the like), so that the incentive can be paid to the provider of the product introduction video.

That is, it can be said that the form of the product sales service is not limited to the one directly managed by the management server 10, as long as the fact of the purchase of the product by the purchaser and the product introduction video that has contributed to the purchase of the product can be specified.

In addition, the product introduction content is not limited to being stored in the management server 10 and provided, and may have any form of provision as long as the viewer who considers purchasing the product can access the product introduction content, such as the case where the product introduction content is stored in an external server managed by a third party. Further, the product introduction content includes a product introduction video and a product introduction voice, but the product introduction content may include, in addition to registering and providing a product introduction video and a product introduction voice that are created in advance, a product introduction content that is shot and released at the same time (live stream, live streaming). In the case of such a form, since it is not possible to determine in advance whether or not the product introduction content complies with the product introduction rule, it is conceivable to determine later whether or not the product introduction content complies with the product introduction rule. If it is confirmed later that the product introduction content complies with the product introduction rule and there is a means to specify that the purchaser of the product has viewed the product introduction content, even when the purchaser watches a live streaming video and then purchases the product, an incentive can be given to the provider of the live streaming video.

In addition, the entire product introduction content does not need to be the introduction of the product. For example, when there is a 15-minute segment that introduces a product midway in a video that is provided by a provider and has a play time of 30 minutes, if it can be specified that a customer has viewed the product introduction part, such a video partially containing the introduction of the product can also be a product introduction video. As a means for specifying the product introduction part, it is possible to conceive various specification means such as a method of separating a product introduction video by time in such a manner that the product introduction part is from 12 minutes to 27 minutes, a method of separating the production introduction part with chapters, and a method of setting the URL of a video that specifies only the product introduction part. As described above, even when a part of the content corresponds to product introduction content, if it can be specified that the purchaser of the product has viewed the part, an incentive can be given to the provider even in the case where a part of the content corresponds to the product introduction content.

That is, the management server according to the present invention includes

a product introduction rule registration means for registering, for each product, a predetermined product introduction rule that needs to be observed in creating a product introduction video as a product introduction content that introduces a product,

a product introduction video registration means for receiving the product introduction video that is created and transmitted by a provider, determining whether or not the product introduction video complies with the product introduction rule, and registering the product introduction video that complies with the product introduction rule in association with the product corresponding to the product introduction video,

a specification means for, when a sale of the product is completed, specifying one or two or more product introduction videos that have contributed to the sale of the product among the product introduction videos that are viewed by a purchaser of the product out of a plurality of the product introduction videos that are registered in association with the product according to a predetermined specification rule determined in advance,

a reward determination means for determining a reward for the provider who provides the product introduction video specified by the specification means according to a predetermined reward determination rule determined in advance, and

a reward information storage means for storing reward information that indicates a reward determined by the reward determination means.

In the above description, the product introduction rule registration means and the product introduction video registration means are achieved by the setting/management unit 120 in the above embodiments, and the specification means, the reward determination means, and the reward information storage means are achieved by the incentive determination processing unit 150 in the above embodiments.

It is needless to mention that the various configurations described in the above embodiments can be applied individually or in combination as appropriate unless a contradiction arises.

### REFERENCE SIGNS LIST

1 System
10 Management server
20 Communication network
30 Terminal (product seller)
40 Terminal (instructor)
50 Terminal (customer)

1. A management server comprising:
a product introduction rule registration means for registering, for each product, a predetermined product introduction rule that needs to be observed in creating a product introduction video as a product introduction content that introduces a product;
a product introduction video registration means for receiving the product introduction video that is created and transmitted by a provider, determining whether or not the product introduction video complies with the product introduction rule, and registering the product introduction video that complies with the product introduction rule in association with the product corresponding to the product introduction video;
a specification means for, when a sale of the product is completed, specifying one or two or more product introduction videos that have contributed to the sale of the product among the product introduction videos that are viewed by a purchaser of the product out of a plurality of the product introduction videos that are registered in association with the product according to a predetermined specification rule determined in advance;
a reward determination means for determining a reward for the provider who provides the product introduction video specified by the specification means according to a predetermined reward determination rule determined in advance; and
a reward information storage means for storing reward information that indicates a reward determined by the reward determination means.

2. The management server according to claim 1, wherein
the specification means sets a condition that a product introduction video that is viewed for a predetermined time or longer by the purchaser is specified as the product introduction video that has contributed to the sale of the product.

3. The management server according to claim 1, wherein
the specification means adopts a specification rule that specifies the product introduction video in which a predetermined part set in advance has been viewed as the product introduction video that has contributed to the sale of the product.

4. The management server according to claim 1, wherein
when the purchaser has viewed a plurality of the product introduction videos before a sale is completed, the specification means adopts a specification rule that specifies n product introduction videos from a product introduction video with a longest viewing time in descending order among a plurality of the product introduction videos as the product introduction videos that have contributed to the sale of the product.

5. The management server according to claim 1, wherein
when the purchaser has viewed a plurality of the product introduction videos before a sale is completed, the specification means adopts a specification rule that specifies n product introduction videos from a product introduction video with the largest number of times of viewing in descending order among a plurality of the product introduction videos as the product introduction videos that have contributed to the sale of the product.

6. The management server according to claim 1, wherein
when the purchaser has viewed a plurality of the product introduction videos before a sale is completed, the specification means adopts a specification rule that acquires selection information in which product introduction videos, the number of which is m or less, that is thought to have contributed to a purchase decision by the purchaser are selected among a plurality of the product introduction videos and that specifies n product introduction videos at most from m product introduction videos selected by the selection information as the product introduction videos that have contributed to the sale of the product.

7. The management server according to claim 6, wherein
the selection information can include ranking information in which the purchaser ranks a plurality of the product introduction videos selected by the purchaser according to a degree of contribution, and
when the product introduction videos, the number of which is less than the number of product introduction videos selected by the purchaser, are specified as the product introduction videos that have contributed to the sale, the specification means adopts a specification rule that specifies n product introduction videos from a product introduction video with a highest ranking in ascending order in the ranking information as the product introduction videos that have contributed to the sale of the product.

8. The management server according to claim 1, wherein
the specification means adopts a specification rule that specifies the product introduction video that has been viewed by the purchaser immediately before the purchaser purchases the product as the product introduction video that has contributed to the sale of the product.

9. The management server according to claim 1, wherein
when a reward is paid to a plurality of the providers, the reward determination means adopts a reward determination rule that rewards a provider who provides a product introduction video that is estimated to have a higher degree of contribution to a sale than other product introduction videos among a plurality of the product introduction videos more than other providers.

10. A management program that causes a management server to implement:
a product introduction rule registration function that registers, for each product, a predetermined product introduction rule that needs to be observed in creating a product introduction video as a product introduction content that introduces a product;
a product introduction video registration function that receives the product introduction video that is created and transmitted by a provider, determines whether or not the product introduction video complies with the product introduction rule, and registers the product introduction video that complies with the product introduction rule in association with the product corresponding to the product introduction video;
a specification function that, when a sale of the product is completed, specifies one or two or more product introduction videos that have contributed to the sale of the product among the product introduction videos that are viewed by a purchaser of the product out of a plurality of the product introduction videos that are registered in association with the product according to a predetermined specification rule determined in advance;
a reward determination function that determines a reward for the provider who provides the product introduction video specified by the specification function according to a predetermined reward determination rule determined in advance; and
a reward information storage function that stores reward information that indicates a reward determined by the reward determination function.
